(19) United States
(12) Patent Application Publication
(10) Pub. No.: US 2025/0109885 A1
(43) Pub. Date: Apr. 3, 2025

(54) SELF-LOCKING SWITCH ASSEMBLY AND HEAT GUN

(71) Applicant: ZHEJIANG PRULDE ELECTRIC APPLIANCE CO., LTD., Jinhua (CN)

(72) Inventor: Chenghao Yang, Jinhua (CN)

(73) Assignee: ZHEJIANG PRULDE ELECTRIC APPLIANCE CO., LTD., Jinhua (CN)

(21) Appl. No.: 18/821,009

(22) Filed: Aug. 30, 2024

(30) Foreign Application Priority Data
Sep. 28, 2023 (CN) 2023226683343

(51) Int. Cl. F24H 3/04; F24H 9/00

(52) U.S. Cl. CPC F24H 3/0423; F24H 9/0052

(57) ABSTRACT

A self-locking switch assembly and heat gun, which relates to power tools; switch assembly includes switch, trigger, holder, self-locking structure, and first elastic member, self-locking structure including toggle button deflectably disposed on trigger and abutment block disposed on holder, toggle button having lock position wherein toggle button abuts against abutment block to prevent trigger from sliding towards switch and unlock position wherein toggle button is detached from abutment block so the trigger may be stressed to slide towards trigger, first elastic member being configured to be stressed and deformed when toggle button is deflected from lock position to unlock position and to drive toggle button to be deflected from unlock position to lock position when toggle button is released, holder being provided with stop portion for preventing toggle button at unlock position from rotating back towards lock position, toggle button at unlock position being fitted with stop portion.

### FIELD

The disclosure relates to a power tool, and more particularly relates to a self-locking switch assembly; the disclosure also relates to a heat gun applying the self-locking switch assembly.

### BACKGROUND

Existing power tools generally leverage a trigger to actuate a switch so as to control activation/deactivation of the gun body, the switch being disposed inside the gun body, the trigger being movably disposed on the gun body. When a user presses the trigger, the trigger is stressed to slide towards the switch to thereby actuate the switch, activating the power tool. When the user releases the trigger, the trigger moves away from the switch to thereby release the switch, deactivating the power tool.

To prevent unintentional actuation of the trigger causing accidental start of the power tool and affecting operational safety, some power tools would arrange a deflectable toggle button on the trigger; the toggle button normally abuts against an abutment block inside the gun body so that even if the trigger is stressed, it still cannot slide towards the switch. Only when the toggle button is deflected to be misaligned with the abutment block, can the trigger be stressed to slide towards the switch to thereby actuate the switch. To allow for the toggle button to stably abut against the abutment block in a normal state, a spring corresponding to the toggle button is disposed in the gun body; the spring is stressed and deformed when the toggle button is deflected to be misaligned with the abutment block. After the user releases the button, the spring recovered from deformation drives the toggle button to automatically reset to a state of abutting against the abutment block. Since the spring imposes a back force on the toggle button when the user presses the trigger, the user needs to urge the toggle button more forcibly to prevent back rotation of the toggle button, which is strenuous for the user to manipulate the power tool, deteriorating operational experience of the user.

### SUMMARY

To overcome the drawbacks and deficiencies in conventional technologies, the disclosure provides a self-locking switch assembly; a toggle button at the unlock position is fitted with a stop portion; fitting between the toggle button and the stop portion may counteract part of an acting force imposed by the first elastic member on the toggle button in driving the toggle button to rotate back from the lock position, which appropriately reduces the acting force needed to press the toggle button so as to maintain the trigger to a switch-actuating state, thereby enhancing manipulation experience of a user.

A self-locking assembly according to the disclosure comprises:
a switch configured to control power-on and power-off;
a trigger slidable toward the switch to actuate the switch or slidable away from the switch to release the switch;
a holder disposed between the switch and the trigger;
a self-locking structure disposed between the trigger and the holder to prevent the trigger from unintentionally pushing the switch, the self-locking structure comprising a toggle button deflectably disposed on the trigger and an abutment block disposed on the holder, the toggle button having a lock position at which the toggle button abuts against the abutment block to prevent the trigger from sliding towards the switch and an unlock position at which the toggle button is detached from the abutment block so that the trigger is stressed to slide towards the trigger; and
a first elastic member acting on the toggle button and configured to be stressed and deformed when the toggle button is deflected from the lock position to the unlock position and to drive the toggle button to be deflected from the unlock position to the lock position when the toggle button is released;
wherein the holder is provided with a stop portion configured to prevent the toggle button at the unlock position from rotating back towards the lock position, the toggle button at the unlock position being fitted with the stop portion.

In some implementations, the holder is disposed at a side of the trigger facing the switch, the toggle button having an outer end extendable out of the trigger and an inner end located inside the trigger, the outer end and the inner end being disposed at two sides of a deflection point of the toggle button, respectively, the inner end being fitted with the stop portion to prevent the toggle button at the unlock position from rotating back.

In some implementations, the stop portion is a stop rib, the inner end of the toggle button at the unlock position abutting against the stop rib to limit the toggle button.

In some implementations, the stop rib is provided with a stop face fitted with the inner end of the toggle button, the inner end of the toggle button at the unlock position abutting against the stop face.

In some implementations, the stop rib is formed with a stop recess fitted with the inner end of the toggle button, the inner end of the toggle button at the unlock position being inserted in the stop recess.

In some implementations, the toggle button is deflectably arranged on the trigger via a pin, the trigger being formed with an opening for mounting the toggle button, the outer end of the toggle button at the lock position extending out of the trigger from the opening, and the outer end of the toggle button at the unlock position being disposed inside the opening and adapted to the opening.

In some implementations, a deflection plane of the toggle button is arranged parallel to a sliding direction of the trigger.

In some implementations, the switch assembly further comprises a locking member configured to lock the trigger to a switch-actuating state and a second elastic member acting on the locking member;
the locking member is movably disposed on the holder, a moving direction of the locking member being perpendicular to the sliding direction of the trigger; and the locking member comprises a locking rod, a grip portion disposed at one end of the locking rod, and a limiting portion disposed at an opposite end of the locking rod, the trigger being formed with a locking hole for the locking rod to insert; and
the second elastic member is configured to be stressed and deformed when the locking rod is inserted in the locking hole and the limiting portion abuts against the trigger, and configured to drive the locking rod to be detached from the locking hole when the limiting portion is detached from the trigger.

In some implementations, the switch assembly further comprises a third elastic member acting on the trigger, the third elastic member being configured to be stressed and deformed when the trigger actuates the switch and to drive the trigger to release the switch when the trigger is released.

The disclosure provides a heat gun, comprising a housing and a hot air assembly disposed in the housing, wherein the heat gun further comprises a self-locking switch assembly as stated supra, the switch assembly being disposed in the housing, the trigger being partially exposed out of the housing.

With the technical solution supra, the present disclosure offers the following benefits:

1. The switch assembly provided herein has a self-locking structure disposed between the trigger and the holder, the toggle button of the self-locking structure being deflectively disposed on the trigger. Since the first elastic member is stressed and deformed when the toggle button is disposed at the unlock position, the deformed first elastic member would impose a force on the toggle button to drive the toggle button to rotate back to the lock position from the unlock position. The stop portion is provided on the holder, and the toggle button at the unlock position is fitted with the stop portion. Fitting between the toggle button and the stop portion can counteract part of the back rotation force imposed by the first elastic member on the toggle button, so that the acting force required to be imposed by the user to the toggle button for preventing back rotation of the toggle button can be appropriately reduced, which eases manipulation of the trigger to a reasonable extent and thus enhances manipulation experience of the user.

2. The toggle button has an inner end and an outer end disposed at two sides of a deflection point of the toggle button, respectively, the outer end of the toggle button extending out of the trigger so that the user may act on the toggle button via the outer end causing the toggle button to smoothly shift from the lock position to the unlock position. The inner end of the toggle button is disposed inside the trigger; when the toggle button is disposed at the unlock position, the inner end of the toggle button is fitted with the stop portion so as to limit the toggle button, which avoids the toggle button from rotating back to the lock position under the action of the first elastic member. Due to reasonable setting of the structure of the toggle button, the toggle button at the unlock position can be smoothly fitted with the stop portion.

3. The stop portion may be set as a stop rib; when the toggle button is disposed at the unlock position, the inner end of the toggle button abuts against the stop rib to thereby limit the toggle button. Due to reasonable setting of the specific structure of the stop portion, the structural requirements for fitting between the stop portion and the toggle button to prevent the toggle button from rotating back towards the lock position from the unlock position are satisfied.

4. The stop rib may be provided with a stop face; when the toggle button is disposed at the unlock position, the inner end of the toggle button abuts against the stop face; the stop face reasonably increases the abutting area between the stop rib and the toggle button, which may further enhance the effect of limiting the toggle button when the inner end of the toggle button abuts against the stop rib.

5. The stop rib may also be formed with a stop recess; when the toggle button is disposed at the unlock position, the inner end of the toggle button is inserted in the stop recess to thereby limit the toggle button; the stop recess may further enhance the effect of limiting the toggle button.

6. When the toggle button is disposed at the lock position, the outer end of the toggle button extends out of the trigger from the opening, which facilitates the user to impose a force on the trigger driving the trigger to be deflected from the lock position to the unlock position. When the toggle button is disposed at the unlock position, the outer end of the toggle button is disposed in the opening and adapted to the opening, which facilitates the user to conveniently drive the trigger to slide towards the switch after the toggle button is deflected to the unlock position.

7. The deflection plane of the toggle button is preferably arranged parallel to the sliding direction of the trigger, so that the direction of the force imposed by the user on the toggle button to shift the toggle button from the lock position to the unlock position is consistent with the direction of the force imposed to drive the trigger to slide towards the switch, which facilitates the user to conveniently act on the trigger after urging the toggle button in place.

8. When the locking rod of the locking member is inserted into the locking hole and the limiting portion abuts against the trigger, the trigger may be securely locked to the switch-actuating state, eliminating a need for the user to keep pressing the trigger when performing a long-run operation, which reasonably eases user manipulation. When the limiting portion is detached from the trigger, the second elastic member recovered from deformation drives the locking rod to be detached from the locking hole so that the locking member may release the trigger in time.

9. When the trigger slides towards the switch to actuate the switch, the third elastic member is stressed and deformed. After the trigger is released, the third elastic member recovered from deformation automatically drives the trigger to slide away from the switch, so that the trigger can release the switch in time, whereby the gun body can be shut down promptly.

### BRIEF DESCRIPTION OF THE DRAWINGS

FIG. 1 is a structural schematic diagram of a switch assembly when a switch is released by a trigger according to a first implementation of the disclosure;

FIG. 2 is an exploded view of the switch assembly according to the first implementation of the disclosure;

FIG. 3 is a sectional view of the switch assembly when a toggle button is disposed at a lock position according to the first implementation of the disclosure;

FIG. 4 is a structural diagram of fitting between the toggle button at the lock position and a holder in the switch assembly according to the first implementation;

FIG. 5 is a structural diagram of the switch assembly when the trigger is locked by a locking member to a switch-actuating state according to the first implementation;

FIG. 6 is a sectional view of the switch assembly when the toggle button is disposed at an unlock position according to the first implementation;

FIG. 7 is a structural diagram of fitting between the toggle button at the unlock position and the holder in the switch assembly according to the first implementation;

FIG. 8 is a structural diagram of a heat gun according to the first implementation;

FIG. 9 is a structural diagram of a hot air assembly in the heat gun according to the first implementation;

FIG. 10 is a structural diagram of fitting between a toggle button at an unlock position and a holder in a switch assembly according to a second implementation;

FIG. 11 is a structural diagram of fitting between a toggle button at an unlock position and a holder in a switch assembly according to a third implementation.

In the drawings: 100—switch assembly; 110—switch; 111—pushbutton; 120—trigger; 121—pressure lever; 122—opening; 123—lug; 124—locking hole; 130—holder; 131—abutment block; 132—stop rib; 133—through hole; 134—locating pillar; 135—stop face; 136—stop recess; 140—toggle button; 141—outer end; 142—inner end; 151—pin; 152—torsion spring; 1521—torsion leg; 160—locking member; 161—locking rod; 162—grip portion; 163—limiting portion; 170—first spring; 180—second spring; 200—housing; 300—hot air assembly; 310—heating wire; 320—fan; 330—electric motor.

### DETAILED DESCRIPTION OF EMBODIMENTS

Hereinafter, the disclosure will be described in further detail through implementations with reference to the accompanying drawings. It needs to be understood that the orientational or positional relationships indicated by the terms “upper,” “lower,” “left,” “right,” “longitudinal,” “transversal,” “inner,” “outer,” “vertical,” “horizontal,” “top,” “bottom,” etc. are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to the disclosure.

### First Implementation

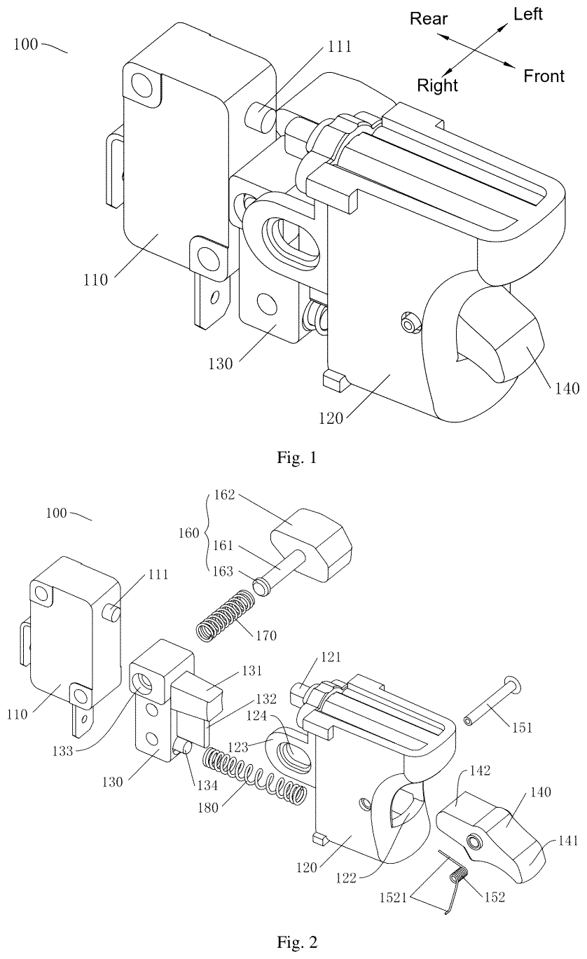

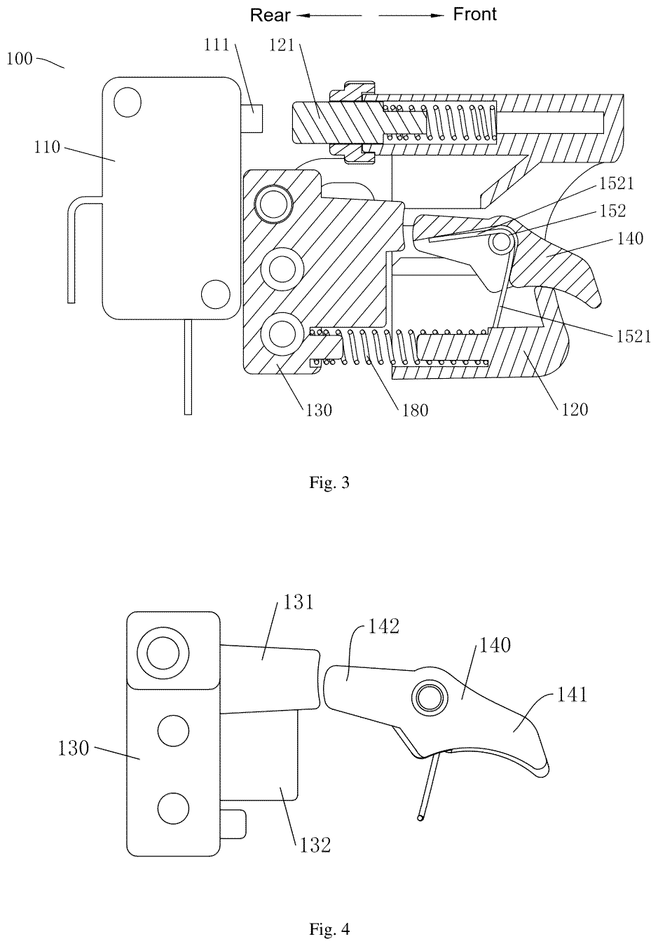

Referring to FIGS. 1 through 7, a self-locking switch assembly 100 according to a first implementation comprises:
a switch 110 configured to control power-on and power-off;
a trigger 120 slidable towards the switch 110 to actuate the switch 110 or slidable away from the switch 110 to release the switch 110;
a holder 130 disposed between the switch 110 and the trigger 120;
a self-locking structure disposed between the trigger 120 and the holder 130 to prevent the trigger 120 from unintentionally pushing the switch 110, the self-locking structure comprising a toggle button 140 deflectably disposed on the trigger 120 and an abutment block 131 disposed on the holder 130, the toggle button 140 having a lock position at which the toggle button 140 abuts against the abutment block 131 to prevent the trigger 120 from sliding towards the switch 110 and an unlock position at which the toggle button 140 is detached from the abutment block 131 so that the trigger 120 is stressed to slide towards the trigger 120;
a first elastic member acting on the toggle button 140 and configured to be stressed and deformed when the toggle button 140 is deflected from the lock position to the unlock position and to drive the toggle button 140 to be deflectively reset from the unlock position to the lock position when the toggle button 140 is released;
the holder 130 is provided with a stop portion configured to prevent the toggle button 140 at the unlock position from rotating back towards the lock position, the toggle button 140 at the unlock position being fitted with the stop portion.

Since the first elastic member is stressed and deformed when the toggle button 140 is disposed at the unlock position, the deformed first elastic member would impose a force on the toggle button 140 to drive the toggle button 140 to rotate back to the lock position from the unlock position. The stop portion is provided on the holder 120, and the toggle button 140 at the unlock position is fitted with the stop portion. Fitting between the toggle button 140 and the stop portion can counteract part of the back rotation force imposed by the first elastic member on the toggle button 140, so that the acting force required to be imposed by a user to the toggle button 140 for preventing back rotation of the toggle button 140 can be appropriately reduced, which eases manipulation of the trigger 120 to a reasonable extent and thus enhances manipulation experience of the user.

In this implementation, the trigger 120 is disposed at a front side of the holder 130, the switch 110 is disposed at a rear side of the holder 130, a pushbutton 111 is disposed at a front side of the switch 110, and a pressure lever 121 protruding rearwardly for pressing the pushbutton 111 is provided on the trigger 120; the trigger 120, when sliding rearward, drives the pressure lever 121 to press the pushbutton 111 to thereby actuate the switch 110; the trigger 120, when sliding forward, drives the pressure lever 121 to release the pushbutton 111 to thereby release the switch 110.

Referring to FIGS. 1, 2, and 3, the toggle button 140 is deflectably arranged on the trigger 120 via a pin 151, a deflection plane of the toggle button 140 being parallel to a sliding direction of the trigger 120. In this implementation, the trigger 120 is formed with an opening 122 for mounting the toggle button 140, the toggle button 140 being disposed at the opening 122 of the trigger 120 via the pin 151 in an up-and-down deflectable manner, where the pin 151 serves as a deflection point of a torsion spring 152. The axial direction of the pin 151 is perpendicular to the sliding direction of the trigger 120, and the deflection plane of the toggle button 140 is a vertical plane perpendicular to the axial direction of the pin 151, the vertical plane being parallel to a fore-and-aft direction.

In some examples, the first elastic member adopts the torsion spring 152, the torsion spring 152 being sleeved over the pin 151, the torsion spring 152 being disposed inside the trigger 120 and having two torsion legs 1521, one torsion leg 1521 thereof abutting against the trigger 120 so as to locate the torsion spring 152, the other torsion leg 1521 abutting against the toggle button 140 so as to act on the toggle button 140. In this implementation, a front end of the toggle button 140 is referred to as an outer end 141 extending out of the trigger 120 via a through hole 133, and a rear end of the toggle button 140 is referred to as an inner end 142 located inside the trigger 120, the outer end 141 and the inner end 142 being disposed at two sides of the pin 151, respectively. Referring to FIG. 4, the abutment block 131 protrudes forward from the front wall of the holder 130; when the toggle button 140 is driven by the preload of the torsion spring 152 to be thereby located at the lock position, the inner end 142 of the toggle button 140 abuts against the abutment block 131, so that the trigger 120 cannot slide rearward even if it is stressed, which prevents the unintentionally pressed trigger 120 from sliding rearward to actuate the switch 110. To actuate the switch 110, the user needs to first impose a force on the outer end 141 of the toggle button 140 causing the outer end 141 of the toggle button 140 to deflect upward by a certain angle; correspondingly, the inner end 142 of the toggle button 140 is deflected downward to detach from the abutment block 131, whereby the toggle button 140 is unlocked and shifted to the unlock position; now, the torsion spring 152 is stressed and deformed to exert a force against the trigger 120 driving the trigger 120 to slide rearward; the rearward sliding trigger 120 drives the pressure lever 121 to press the pushbutton 111, thereby actuating the switch 110. To improve the user's touch sensation in manipulation, the outer end 141 of the toggle button 140 at the unlock position is disposed inside the opening 122 and adapted to the opening 122, the surface of the toggle button 140 substantially coinciding with the contour line of the front surface of the trigger 120 so that the outer end of the toggle button 140 is combined with the trigger 120 to form an integral trigger structure. It may be understood that, the outer end 141 of the trigger 120 may be deflected upward in place till abutting against the inner top wall of the opening 122, or deflected upward in place till engaging a limit stop structure inside the trigger 120.

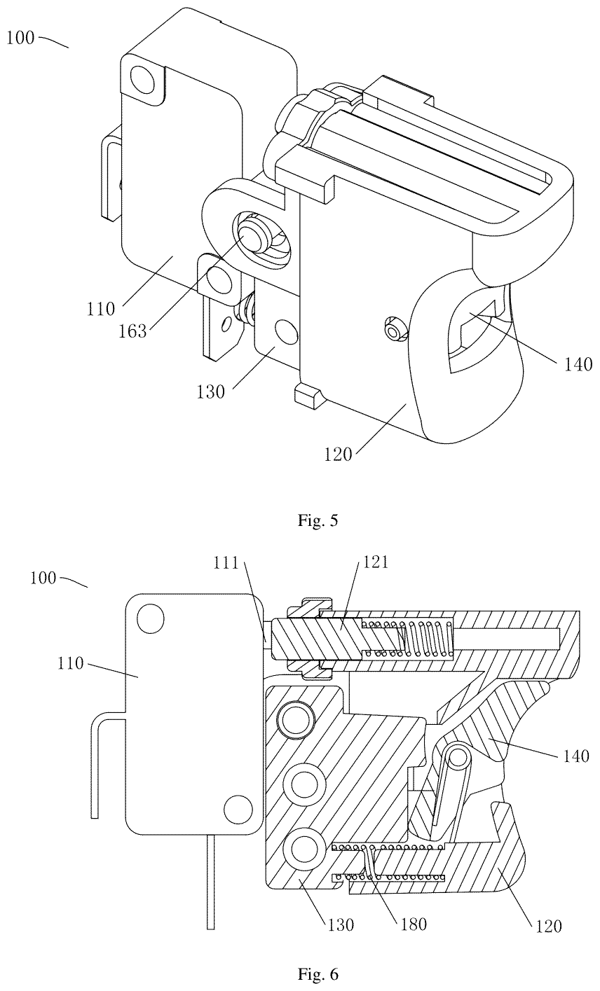

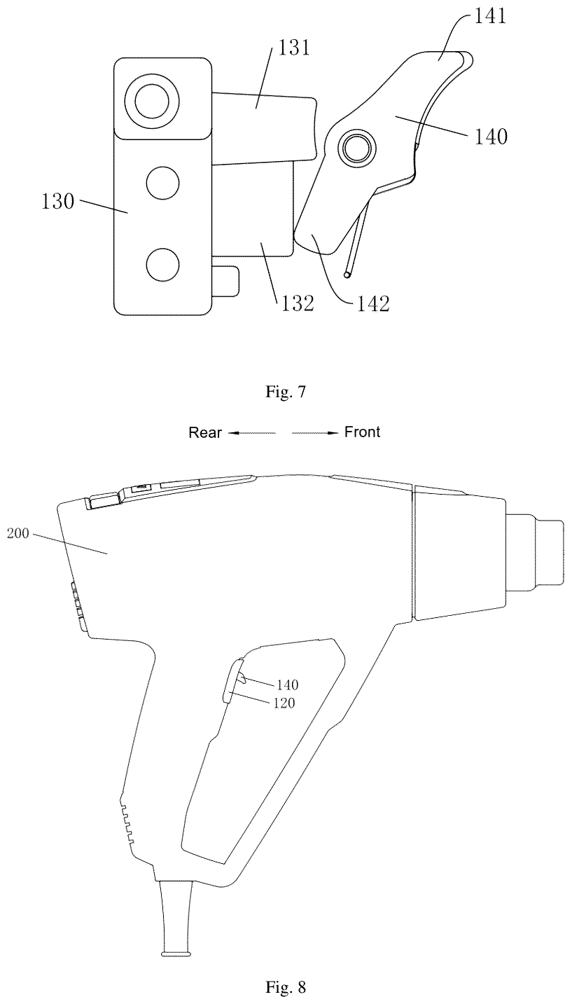

In this implementation, the stop portion is fitted with the inner end 142 of the toggle button 140 to prevent the toggle button 140 at the unlock position from rotating back. Referring to FIGS. 6 and 7, the stop portion is a stop rib 132 disposed at the front side of the holder 130; when the trigger 120 is driven by the toggle button 140 at the unlock position to slide rearward to actuate the switch 110, the inner end 142 of the toggle button 140 abuts against the stop rib 132, whereby the toggle button 140 is limited, and this limitation counteracts at least part of the back rotation force imposed by the deformed torsion spring 152 on the toggle button 140, thereby reducing a sliding forward tendency of the trigger 120 driven by the toggle button 140 under the back rotation force of the torsion spring 152, retaining the toggle button 140 stably to the unlock position, further reducing the action force imposed by the user against the trigger 120 to retain the trigger 120 stably in a state of actuating the switch 110.

Referring to FIG. 2 and FIG. 5, to eliminate a need for the user to keep pressing on the trigger 120 when performing a long-running operation, the switch assembly 100 further comprises a locking member 160 configured to lock the trigger 120 to the state of actuating the switch 110 and a second elastic member acting on the locking member 160. In this implementation, the locking member 160 is left-and-right movably disposed on the holder 130, the holder 130 being formed with a through hole 133 for mounting the locking member 160, a movable direction of the locking member 160 being perpendicular to a sliding direction of the trigger 120. Specifically, the locking member 160 comprises a locking rod 161 extending through the through hole 133, a grip portion 162 disposed at one end of the locking rod 161, and a limiting portion 163 disposed at an opposite end of the locking rod 161, an outer diameter of the limiting portion 163 being greater than a diameter of the locking rod 161. In some examples, the second elastic member is a first spring 170, the first spring 170 being sleeved over the locking rod 161, one end of the first spring 170 abutting against an inner wall of the through hole 133 so as to locate the first spring 170, an opposite end thereof abutting against the grip portion 162 so as to engage the locking member 160. The trigger 120 is provided with a lug 123 protruding rearwardly, a locking hole 124 for the locking rod 161 to insert being formed on the lug 123, an inner diameter of the locking hole 124 being greater than an outer diameter of the limiting portion 163.

The switch assembly 100 further comprises a third elastic member acting on the trigger 120, the third elastic member being configured to be stressed and deformed when the trigger 120 actuates the switch 110 so as to drive the trigger 120 to release the switch 110 when the trigger 120 is released. In this implementation, the third elastic member adopts a second spring 180, one end of the second spring 180 being inserted in a blind hole of the trigger 120 so as to abut against the trigger 120, an opposite end of the second spring 180 being sleeved over a locating pillar 134 of the holder 130 so as to abut against the holder 130. When the trigger 120 slides rearward to actuate the switch 110, the second spring 180 is stressed and deformed. When the trigger 120 is released, the second spring 180 recovered from deformation drives the trigger 120 to slide forward to release the switch 110.

To activate the gun body, a force is first imposed on the toggle button 140 so that the toggle button 140 overcomes the preload of the torsion spring 152 so as to be deflected from the lock position illustrated in FIG. 4 to the unlock position; during this process, the torsion spring 152 is stressed and deformed; then, the toggle button 140 may be further stressed so that the trigger 120 overcomes the preload of the second spring 180 to slide rearward to actuate the switch 110; now, the inner end 142 of the toggle button 140 at the unlock position abuts against the stop rib 132, whereby the toggle button 140 is limited.

When the trigger 120 needs to be locked after actuating the switch 110, a force is imposed on the locking member 160 via the grip portion 162 so that the locking rod 161 is inserted in the locking hole 124 and the limiting portion 163 leftward and rightward abuts against the lug 123. Now, the first spring 170 is stressed and deformed; the trigger 120, when being locked by the locking member 160, cannot slide forward under the elastic action of the second spring 180 so that the switch 110 cannot be released.

To shut down the gun body, a force is first imposed on the trigger 120 so that the trigger 120 slides rearward by a certain distance driving the limiting portion 163 to be detached from the lug 123, and the first spring 170 recovered from deformation drives the locking member 160 to slide so that the locking rod 161 is detached from the locking hole 124, whereby locking between the locking member 160 and the trigger 120 is released, and then the second spring 180 recovered from deformation drives the trigger 120 to slide forward so that the trigger 120 releases the switch 110; meanwhile, the torsion spring 152 recovered from deformation drives the inner end 142 of the toggle button 140 to be deflected upward so that the inner end 142 of the toggle button 140 abuts against the abutment block 131, whereby the toggle button 140 resumes the lock position.

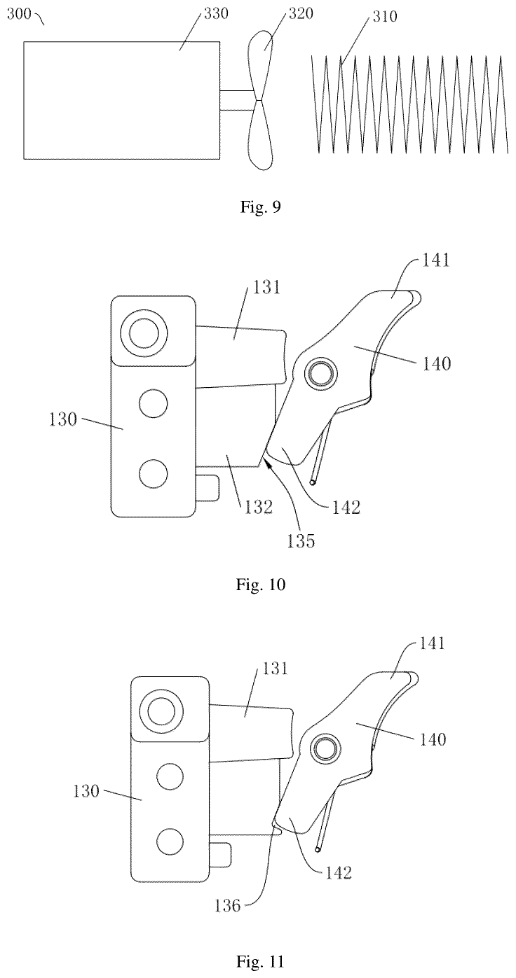

Referring to FIGS. 8 and 9, this implementation further provides a heat gun, comprising: a housing 200, a hot air assembly 300 disposed in the housing 200, and the switch assembly 100 as described supra, the switch assembly 100 being disposed in the housing 200, the front portion of the trigger 120 being exposed out of the housing 200. The hot air assembly 300 comprises a heating wire 310, a fan 320 disposed rear to the heating wire 310, and an electric motor 330 configured to actuate the fan 320. Other structural details of the heat gun may refer to conventional technologies, which are not detailed herein. It may be understood that, the heat gun may be powered by a battery or powered directly by the mains electricity via an electrical wire. It may be understood that, a specific structure of the heat gun is not limited to the pattern illustrated in the drawings, but may be designed into other reasonable patterns.

It may be understood that, the outer end 141 of the torsion button 140 may also be deflected downward when the toggle button 140 is deflected from the lock position to the unlock position; in this case, the inner end 142 of the toggle button 140 is deflected upward when the toggle button 140 is deflected from the lock position to the unlock position. To enable the inner end 142 of the toggle button 140 to be fitted with the stop rib 142 so as to limit the toggle button 140, the stop rib 132 is disposed above the abutment block 131.

It may be understood that, the toggle spring 152 may alternatively adopt a spring, one end of the spring abutting against the inner end 142 of the toggle button 140, an opposite end thereof abutting against the trigger 120.

### Second Implementation

Referring to FIG. 10, in this implementation, the stop rib 132 is provided with a stop face 135 fitted with the inner end 142 of the toggle button 140; when the toggle button 140 is disposed at the unlock position, the surface of the inner end 142 of the toggle button 140 abuts against the stop face 135; the stop face 135 reasonably increases the abutting area between the stop rib 132 and the toggle button 140, which may further enhance the effect of limiting the toggle button 140 when the inner end 142 of the toggle button 140 abuts against the stop rib 132.

It may be understood that, the stop face 135 may be formed as a beveled surface, or an arc surface, or a surface of other pattern mated to the inner end 142.

The other structures of the second implementation are identical to those of the first implementation, which will not be detailed one by one here.

### Third Implementation

Referring to FIG. 11, in this implementation, the sop rib 132 is formed with a stop recess 136 fitted with the inner end 142 of the toggle button 140; the inner end 142 of the toggle button 140 at the unlock position is inserted in the stop recess 136 so as to limit the toggle button 140, whereby the effect of limiting the toggle button 140 may be further enhanced when the inner end 142 of the toggle button 140 abuts against the stop rib 132.

The other structures of the third implementation are identical to those of the first implementation, which will not be detailed here one by one.

Besides the example implementations described supra, the present disclosure also has other implementations; those skilled in the art may make various changes and alternations to the disclosure; without departing from the spirit of the disclosure, such changes and alterations all fall into the scope of the appended claims.

1. A self-locking switch assembly, comprising:
a switch configured to control power-on and power-off;
a trigger slidable toward the switch to actuate the switch or slidable away from the switch to release the switch;
a holder disposed between the switch and the trigger;
a self-locking structure disposed between the trigger and the holder to prevent the trigger from unintentionally pushing the switch, the self-locking structure comprising a toggle button deflectably disposed on the trigger and an abutment block disposed on the holder, the toggle button having a lock position at which the toggle button abuts against the abutment block to prevent the trigger from sliding towards the switch and an unlock position at which the toggle button is detached from the abutment block so that the trigger is stressed to slide towards the trigger; and
a first elastic member acting on the toggle button and configured to be stressed and deformed when the toggle button is deflected from the lock position to the unlock position and to drive the toggle button to be deflected from the unlock position to the lock position when the toggle button is released;
wherein the holder is provided with a stop portion configured to prevent the toggle button at the unlock position from rotating back towards the lock position, the toggle button at the unlock position being fitted with the stop portion.

2. The self-locking switch assembly according to claim 1, wherein the holder is disposed at a side of the trigger facing the switch, the toggle button having an outer end extendable out of the trigger and an inner end located inside the trigger, the outer end and the inner end being disposed at two sides of a deflection point of the toggle button, respectively, the inner end being fitted with the stop portion to prevent the toggle button at the unlock position from rotating back.

3. The self-locking switch assembly according to claim 2, wherein the stop portion is a stop rib, the inner end of the toggle button at the unlock position abutting against the stop rib to limit the toggle button.

4. The self-locking switch assembly according to claim 3, wherein the stop rib is provided with a stop face fitted with the inner end of the toggle button, the inner end of the toggle button at the unlock position abutting against the stop face.

5. The self-locking switch assembly according to claim 3, wherein the stop rib is formed with a stop recess fitted with the inner end of the toggle button, the inner end of the toggle button at the unlock position being inserted in the stop recess.

6. The self-locking switch assembly according to claim 2, wherein the toggle button is deflectably arranged on the trigger via a pin, the trigger being formed with an opening for mounting the toggle button, the outer end of the toggle button at the lock position extending out of the trigger from the opening, and the outer end of the toggle button at the unlock position being disposed inside the opening and adapted to the opening.

7. The self-locking switch assembly according to claim 6, wherein a deflection plane of the toggle button is arranged parallel to a sliding direction of the trigger.

8. The self-locking switch assembly according to claim 1, wherein the switch assembly further comprises a locking member configured to lock the trigger to a switch-actuating state and a second elastic member acting on the locking member;
the locking member is movably disposed on the holder, a moving direction of the locking member being perpendicular to the sliding direction of the trigger; and the locking member comprises a locking rod, a grip portion disposed at one end of the locking rod, and a limiting portion disposed at an opposite end of the locking rod, the trigger being formed with a locking hole for the locking rod to insert; and
the second elastic member is configured to be stressed and deformed when the locking rod is inserted in the locking hole and the limiting portion abuts against the trigger, and configured to drive the locking rod to be detached from the locking hole when the limiting portion is detached from the trigger.

9. The self-locking switch assembly according to claim 1, wherein the switch assembly further comprises a third elastic member acting on the trigger, the third elastic member being configured to be stressed and deformed when the trigger actuates the switch and to drive the trigger to release the switch when the trigger is released.

10. (canceled)

11. A heat gun, comprising a housing and a hot air assembly disposed in the housing, wherein the heat gun further comprises a self-locking switch assembly according to claim 1, the switch assembly being disposed in the housing, the trigger being partially exposed out of the housing.

12. A heat gun, comprising a housing and a hot air assembly disposed in the housing, wherein the heat gun further comprises a self-locking switch assembly according to claim 2, the switch assembly being disposed in the housing, the trigger being partially exposed out of the housing.

13. A heat gun, comprising a housing and a hot air assembly disposed in the housing, wherein the heat gun further comprises a self-locking switch assembly according to claim 3, the switch assembly being disposed in the housing, the trigger being partially exposed out of the housing.

14. A heat gun, comprising a housing and a hot air assembly disposed in the housing, wherein the heat gun further comprises a self-locking switch assembly according to claim 4, the switch assembly being disposed in the housing, the trigger being partially exposed out of the housing.

15. A heat gun, comprising a housing and a hot air assembly disposed in the housing, wherein the heat gun further comprises a self-locking switch assembly according to claim 5, the switch assembly being disposed in the housing, the trigger being partially exposed out of the housing.

16. A heat gun, comprising a housing and a hot air assembly disposed in the housing, wherein the heat gun further comprises a self-locking switch assembly according to claim 6, the switch assembly being disposed in the housing, the trigger being partially exposed out of the housing.

17. A heat gun, comprising a housing and a hot air assembly disposed in the housing, wherein the heat gun further comprises a self-locking switch assembly according to claim 7, the switch assembly being disposed in the housing, the trigger being partially exposed out of the housing.

18. A heat gun, comprising a housing and a hot air assembly disposed in the housing, wherein the heat gun further comprises a self-locking switch assembly according to claim 8, the switch assembly being disposed in the housing, the trigger being partially exposed out of the housing.

19. A heat gun, comprising a housing and a hot air assembly disposed in the housing, wherein the heat gun further comprises a self-locking switch assembly according to claim 9, the switch assembly being disposed in the housing, the trigger being partially exposed out of the housing.
